(19) United States
(12) Patent Application Publication
(10) Pub. No.: US 2011/0286055 A1
(43) Pub. Date: Nov. 24, 2011

(54) READING APPARATUS, IMAGE FORMING APPARATUS AND IMAGE READING CONTROL METHOD

(75) Inventors: Yusuke Hashizume, Chiba-ken (JP); Sueo Ueno, Shizuoka-ken (JP); Katsuya Nagamochi, Tokyo (JP); Hiroyuki Shiraishi, Shizuoka-ken (JP); Koji Shimokawa, Shizuoka-ken (JP); Jun Sakakibara, Tokyo (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/110,732

(22) Filed: May 18, 2011

Related U.S. Application Data
(60) Provisional application No. 61/346,416, filed on May 19, 2010.

(51) Int. Cl. H04N 1/04

(52) U.S. Cl. 358/482

(57) ABSTRACT

An image forming apparatus is provided which can form an image of excellent picture quality in which a streak does not appear at a specified position in a main scanning direction. A reading control apparatus includes an illuminator to irradiate an illumination light to a document of a reading object, a CCD sensor that includes a plurality of light-receiving elements arranged in one line to receive the illumination light reflected by the document, and sequentially outputs electric signals stored in the light-receiving elements, a read control part that acquires, with respect to the electric signals of each line generated by the CCD sensor, electric signals by reading the electric signals starting from an electric signal corresponding to a position outside one end, in a main scanning direction, which is one of both ends of the document of the reading target in the main scanning direction and is the end where an electric signal is outputted from the CCD sensor at an earlier timing, a pre-processing part to perform a specified pre-process on the electric signals acquired by the read control part, and an image output control part that removes, with respect to the electric signals of each line, electric signals corresponding to a range outside the one end from the electric signals processed by the pre-processing part, acquires electric signals starting from the electric signal corresponding to the one end, and outputs only the acquired electric signals to outside.

### CROSS-REFERENCE TO RELATED APPLICATION

This application is based upon and claims the benefit of priority from U.S. provisional application No. 61/346416, filed on May 19, 2010; the entire contents of which are incorporated herein by reference.

### FIELD

Embodiments described herein relate generally to an image forming apparatus including an image reading part to read an image of a document.

### BACKGROUND

Hitherto, an image forming apparatus such as an MFP (Multi Function Peripheral) includes an image reading apparatus to read an image of a document in order to perform a scan process or a copy process. In a reading process of the image reading apparatus, a CCD (Charge Coupled Device) sensor photoelectrically converts the reflected light of light irradiated to the document, converts optical image data into an electric signal (analog signal), and converts the electric signal into a digital signal. The digital signal is subjected to necessary correction such as shading correction and inter-line correction process and is outputted as image data.

In the image data outputted in the reading process as stated above, a streak can occur at a specific timing, which does not exist in the image of the original document, by various noises generated during the reading process of the image.

### DESCRIPTION OF THE DRAWINGS

FIG. 1 is a structural view showing a structure of an image forming apparatus of an embodiment.

FIG. 2 is an enlarged view of a read part of the image forming apparatus of the embodiment.

FIG. 3 is a block diagram of the image forming apparatus of the embodiment.

FIG. 4 is a schematic view when a document glass is seen from an arrow A direction in FIG. 2.

FIG. 5 is a flowchart for explaining a flow of a reading control method.

### DETAILED DESCRIPTION

In general, according to one embodiment, an image reading control apparatus includes an illuminator, a CCD sensor, a read control part, a pre-processing part and an image output control part. The illuminator irradiates an illumination light to a document of a reading object. The CCD sensor includes plural light-receiving elements arranged in one line to receive the illumination light reflected by the document, and sequentially outputs electric signals stored in the light-receiving elements. With respect to the electric signals of each line generated by the CCD sensor, the read control part acquires electric signals by reading the electric signals from an electric signal corresponding to a position outside one end, in a main scanning direction, which is one of both ends, in the main scanning direction, of the document of the reading target (object area as the reading object) and is an end where the electric signal is outputted from the CCD sensor at an earlier timing. The pre-processing part performs a specified pre-process on the electric signals acquired by the read control part. With respect to the electric signals of each line, the image output control part removes electric signals corresponding to a range outside the one end from the electric signals processed by the pre-processing part, acquires electric signals starting from the electric signal corresponding to the one end, and outputs only the acquired electric signals to outside.

### FIRST EMBODIMENT

Hereinafter, a first embodiment will be described with reference to the drawings.

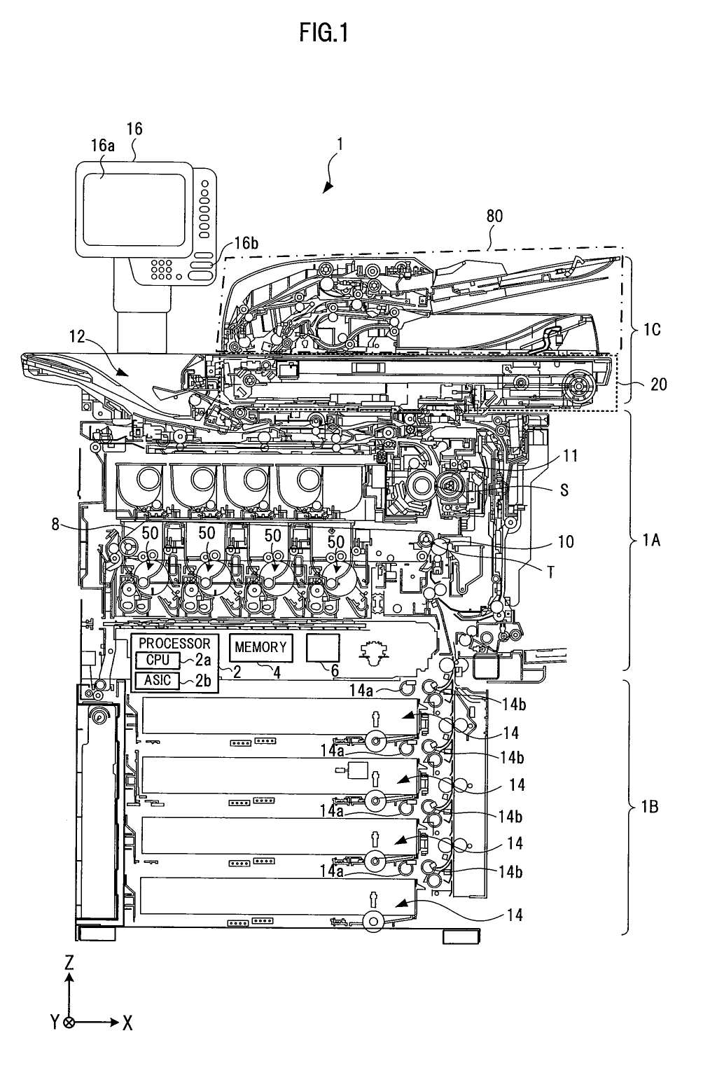

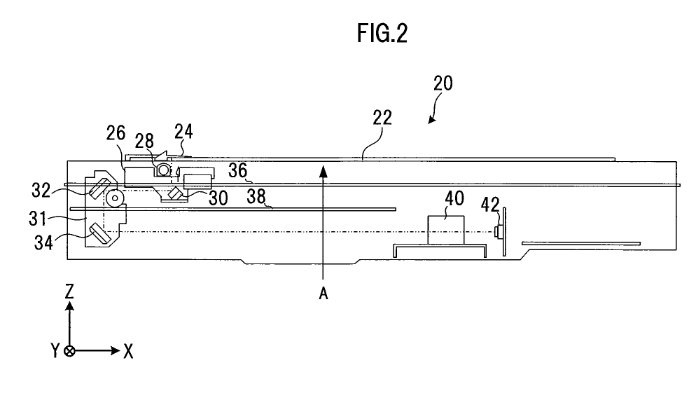

FIG. 1 is a structural view showing a structure of an image forming apparatus 1 of this embodiment. Incidentally, the section of the image forming apparatus 1 shown in FIG. 1 is the section seen from the front side of the apparatus. FIG. 2 is an enlarged view of a read part 20 of the image forming apparatus 1 of the embodiment shown in FIG. 1.

The image forming apparatus 1 is an MFP (Multi Function Peripheral) to perform printing, copying, scanning and the like. The image forming apparatus 1 includes an image forming part 1A, a sheet supply part 1B, an image reading part 1C, a processor 2, a memory 4, an auxiliary storage device 6, an operation panel 16 and the like.

First, at the time of a print process or a copy process, the image forming part 1A performs a process of forming an image on a sheet. The image forming part 1A forms the image on the sheet, such as a paper, supplied from the sheet supply part 1B based on a print job or a copy job. In the case of the copy process, the image is formed on the sheet based on image data generated by reading the document by the image reading part 1C.

The image forming part 1A includes four process units 50 corresponding to toners (developers) of yellow, magenta, cyan and black. Further, the image forming part 1A includes an intermediate transfer belt 8, a secondary transfer roller 10, a fixing unit 11, a discharge tray 12 and the like.

The respective process units 50 form toner images (developer images) of the corresponding colors on the intermediate transfer belt 8. The process unit 50 includes a photoreceptor, a toner cartridge, a cleaner, a developing unit and the like. The toner image is formed on the surface of the photoreceptor and the toner image is primarily transferred to the intermediate transfer belt 8. The toner cartridge stores toner of each color. The toner cartridge supplies the toner to the corresponding developing unit. After the toner image is transferred from each photoreceptor to the intermediate transfer belt 8, the cleaner scrapes and collects the toner remaining on the surface of the photoreceptor. The developing unit supplies the toner to the photoreceptor.

The toner images of the respective colors formed on the photoreceptors are overlappingly transferred (primarily transferred) from the photoconductive drums to the intermediate transfer belt 8, and one toner image is formed on the intermediate transfer belt 8. The intermediate transfer belt 8 transfers the formed toner image to a sheet at a secondary transfer position T.

The secondary transfer roller 10 is arranged to be opposite to a secondary transfer opposite roller across the intermediate transfer belt 8 at the secondary transfer position T. The secondary transfer roller 10 nips the sheet in cooperation with the belt surface of the intermediate transfer belt 8, and transfers the toner image on the intermediate transfer belt 8 to the conveyed sheet.

The fixing unit 11 fixes the toner image, which is transferred to the sheet at the secondary transfer position T, at a fixing position S by heat to the sheet. The sheet on which the toner is fixed is discharged to the discharge tray 12.

The outline of an image forming process by the image forming part 1A including the above structure will be described. First, when the image forming apparatus 1 acquires a copy job or a print job, based on the image data of the acquired jobs a laser beam is irradiated to the surface of the photoreceptor charged by the charging charger of each of the process units 50 and an electrostatic latent image is formed. The developing unit supplies the toner to the photoconductive drum on which the electrostatic latent image is formed. The electrostatic latent image formed on the photoreceptor is visualized by the supply of the toner. The photoreceptor primarily transfers the toner image to the intermediate transfer belt 8 at the primary transfer position where the primary transfer roller is arranged.

The toner images of the respective colors are sequentially primarily transferred from the photoreceptors by the rotation of the intermediate transfer belt 8 and the photoreceptors. When the toner image corresponding to the image data is formed on the intermediate transfer belt 8, the toner image is secondarily transferred to the sheet conveyed from a paper feed cassette 14 at the secondary transfer position T.

The sheet on which the toner image is transferred is moved to the fixing unit 11. The fixing unit 11 fixes the toner image to the sheet by heating. The sheet on which the toner image is fixed passes along a conveyance path and is discharged to the discharge tray 12.

The above is the outline of the image forming process by the image forming apparatus 1.

The sheet supply part 1B supplies a sheet to the image forming part 1A. The sheet supply part 1B includes the paper feed cassette 14, a pickup roller 14a, a paper feed roller 14b and the like. Incidentally, FIG. 1 shows the image forming apparatus including the four paper feed cassettes 14, the four pickup rollers 14a and the like.

The paper feed cassette 14 contains sheets, such as papers, on which images are formed. When images are formed, the pickup roller 14a arranged for each paper feed cassette takes out sheets one by one from the paper feed cassette 14. The taken-out sheets are sequentially conveyed to the secondary transfer position T by the paper feed roller 14b and the like arranged at the downstream side in the sheet conveyance direction.

The image reading part 1C is an apparatus to read an image from a document when copying or scanning is performed, and is an image reading apparatus provided in a copy machine or a scanner. The image reading part 1C includes a read part 20 and an auto duplex document feeder 80.

The read part 20 is a device which reads an image of a document placed on a document glass 22 and generates an electric signal constituting image data. As shown in FIG. 2, the read part 20 includes the document glass 22, a shading correction plate 24, a first carriage 26, an exposure lamp 28, a first mirror 30, a second carriage 31, a second mirror 32, a third mirror 34, carriage rails 36 and 38, a lens 40, a CCD sensor 42 and the like.

The document glass 22 is for placing thereon a document of a reading object. When a reading process is performed, a light from the exposure lamp 28 provided in the first carriage 26 is irradiated through the document glass 22 to the document placed on the document glass 22. The light irradiated to the document is reflected by the first mirror 30, the second mirror 32 and the like described later, and is guided to the CCD sensor 42.

The shading correction plate 24 is the plate for performing a shading correction, and is a white plate having uniform luminance in whole and for reading an image. The shading correction plate 24 is arranged at the back side (side where the first carriage 26 or the exposure lamp 28 is arranged) of a document striking guide (hereinafter referred to also as “guide”) 25a which becomes a reference when the document is placed on the document glass 22. A shift between the luminance of an original image and the luminance of an obtained image, which is caused by a variation in sensitivity of an optical system of the read part 20 and the CCD sensor 42, can be corrected by using an image obtained by reading the shading correction plate 24.

In order to read the document placed on the document glass 22, the first carriage 26 and the second carriage 31 move the exposure lamp 28, the first mirror 30, the second mirror 32, the third mirror 34 and the like in the sub-scanning direction along the carriage rails 36 and 38. The first carriage 26 and the second carriage 31 are moved by driving of a not-shown motor. The exposure lamp 28 and the first mirror 30 are arranged in the first carriage 26. The second mirror 32 and the third mirror 34 are arranged in the second carriage 31. Incidentally,

FIG. 2 shows a state in which the first carriage 26 and the second carriage 31 are slightly moved in the X-axis direction in FIG. 2.

The lens 40 converges the reflected light from the first mirror 30 through the third mirror 34 onto the CCD sensor 42.

The CCD sensor 42 photoelectrically converts the reflected light converged by the lens 40 and converts optical image data into an electric signal. The CCD sensor 42 will be described in more detail in the explanation of the block diagram described later.

The operation of the reading process of the read part 20 will be described. The exposure lamp 28 irradiates light while the first carriage 26 and the second carriage 31 move in the sub-scanning direction (X-axis direction of FIG. 2). The irradiated light impinges on the document through the document glass 22 and is reflected. The reflected light is reflected by the first mirror 30, and is further reflected by the second mirror 32 and the third mirror 34 arranged in the second carriage 31. The light reflected by the third mirror 34 passes through the lens 40, is converged onto the CCD sensor 42, is photoelectrically converted by the CCD sensor 42, and is outputted as an electric signal. The first carriage 31 moves in the sub-scanning direction and scans the whole document, so that image data as electric signals of the whole image can be obtained.

The processor 2 is a processing device to control various processes in the image forming part 1A, the sheet supply part 1B, the image reading part 1C and the like.

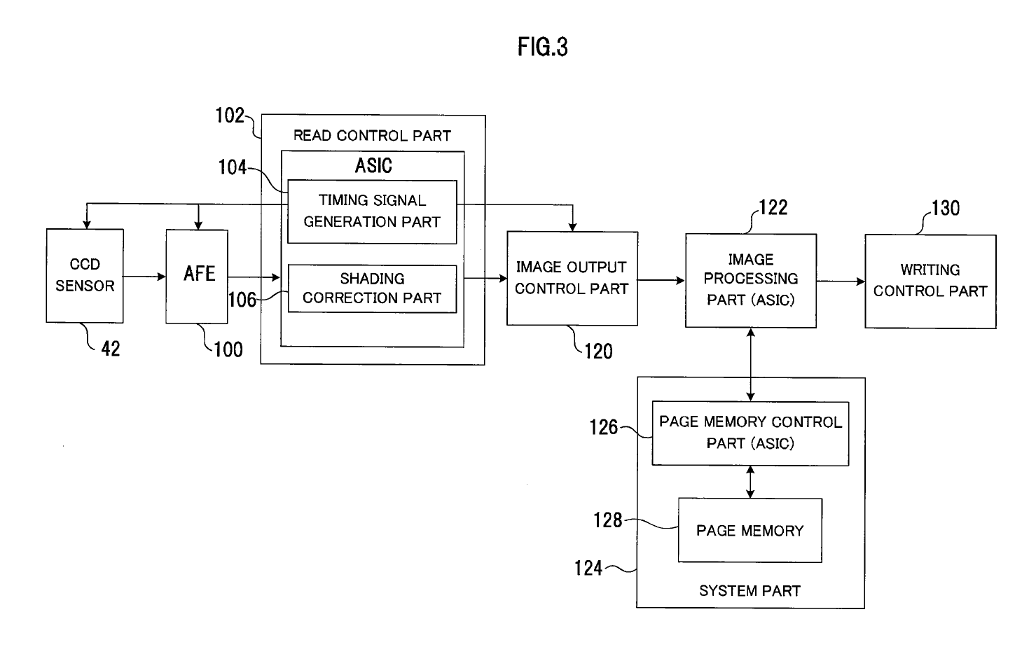

Further, in order to prevent a streak, which does not exist in the image of the document, from appearing at a specific position, in the main scanning direction, of the image data outputted from the read part 20 in the document reading process, the processor 2 of the embodiment performs a control to start reading by the CCD sensor 42 from a position before a reading start position of related art. This function will be described in detail in the explanation of a block diagram of FIG. 3.

The processor 2 executes programs stored in the memory 4 or the auxiliary storage device 6, and realizes various functions and executes processes. The processor 2 of the embodiment includes a CPU (Central Processing Unit) 2a and an ASIC (Application Specific Integrated Circuit) 2b.

Incidentally, an MPU (Micro Processing Unit) or the like capable of executing an arithmetic processing equivalent to the CPU may be used instead of the CPU 2a. Besides, the function of the processor 2 may be realized only by the CPU 2a, or may be realized only by the ASIC 2b.

The memory 4 is the so-called main storage device. The memory 4 is the main storage device and stores programs for enabling the processor 2 to execute processes such as an image forming process in the image forming part 1A, a sheet supply process in the sheet supply part 1B, and an image reading process in the image reading part 1C. Besides, the memory 4 provides the processor 2 with a temporal work area. As the memory 4, for example, a RAM (Random Access Memory), a ROM (Read Only Memory), a DRAM (Dynamic Random Access Memory), an SRAM (Static Random Access Memory), a VRAM (Video RAM), a flash memory or the like is used.

The auxiliary storage device 6 stores various information in the image forming apparatus 1. The auxiliary storage device 6 may store programs stored in the memory 4 described above. As the auxiliary storage device 6, for example, a magnetic storage device such as a hard disk drive, an optical storage device, a semiconductor storage device (flash memory, etc.) or a combination of these storage devices is used.

The operation panel 16 includes a touch panel display part 16a, and various operation keys 16b. The display part 16a displays, for example, a print condition such as a sheet size, the number of copies, print density setting or finishing (stitching, folding), and an operation state of the image forming apparatus 1. The operation key 16b includes, for example, a numeric keypad, a reset key, a stop key and a start key. The user can input instructions and operations to various processes and the display of the display part 16a through the touch panel of the display part 16a or the operation key 16b.

Next, an image reading control process (method) of the image forming apparatus 1 of the embodiment will be described. FIG. 3 is a block diagram for explaining the function and structure of the image reading process of the image forming apparatus 1 of the embodiment. Incidentally, a part of the block shown in FIG. 3 is realized by the processor 2 and by executing programs relating to the reading process stored in the memory 4 or the auxiliary storage device 6, and a part thereof is realized by the ASIC.

The image forming apparatus 1 includes the CCD sensor 42 described above, an AFE (Analog Front End) 100, a read control part 102, an image output control part 120, an image processing part 122, a system part 124 and a writing control part 130.

The CCD sensor 42 converts light into electric charges (electric signals) for respective light-receiving elements, and sequentially outputs the electric charges to the AFE 100 from the electric charge corresponding to the first light-receiving element. The CCD sensor 42 includes the plural light-receiving elements arranged in one line, a CCD (Charge Coupled Device) to sequentially output electric charges stored in the respective light-receiving elements on the basis of a clock from a timing signal generating part 104 and the like. The outputted electric charges are converted into electric signals and are outputted to the AFE 100. The respective light-receiving elements correspond to respective pixels in the image data.

The AFE 100 is a circuit to convert the electric signal of the analog signal from the CCD sensor 42 into a digital signal. The AFE 100 may have a function to amplify the electric signal of the analog signal. Similarly to the CCD sensor 42, also in the AFE 100, the timings when the digital signals corresponding to the respective pixels in the image data are sequentially outputted to the read control part 102 are controlled by the signals from the timing signal generating part 104.

The read control part 102 controls various processes in the read part 20. Besides, the read control part 102 includes the timing signal generation part 104 and a shading correction part 106 as a pre-processing part, which are realized by the ASIC.

As described above, the timing signal generation part 104 outputs signals to control electric signal output timings to the CCD sensor 42, the AFE 100 and the after-mentioned image output control part 120.

The shading correction part 106 performs a shading correction process to correct a light distribution variation of the exposure lamp 28 as the light source, a difference in the amount of light reaching the CCD sensor 42, which is caused by convergence of the reflected light by the lens 40, and a variation in photoelectric conversion amount between the respective elements constituting the CCD sensor 42. The foregoing variation is corrected based on black data and white data previously read by using the shading correction plate 24.

Among digital signals corresponding to the respective pixels of one line outputted from the AFE 100, signals starting from a signal of a pixel corresponding to a position of an end of the document of the reading object in the main scanning direction are generally adopted as image data. However, the read control part 102 of the embodiment starts to read signals from a signal corresponding to a pixel a specified number of pixels earlier than the pixel corresponding to the position of the end of the document and adopts the signals as image data.

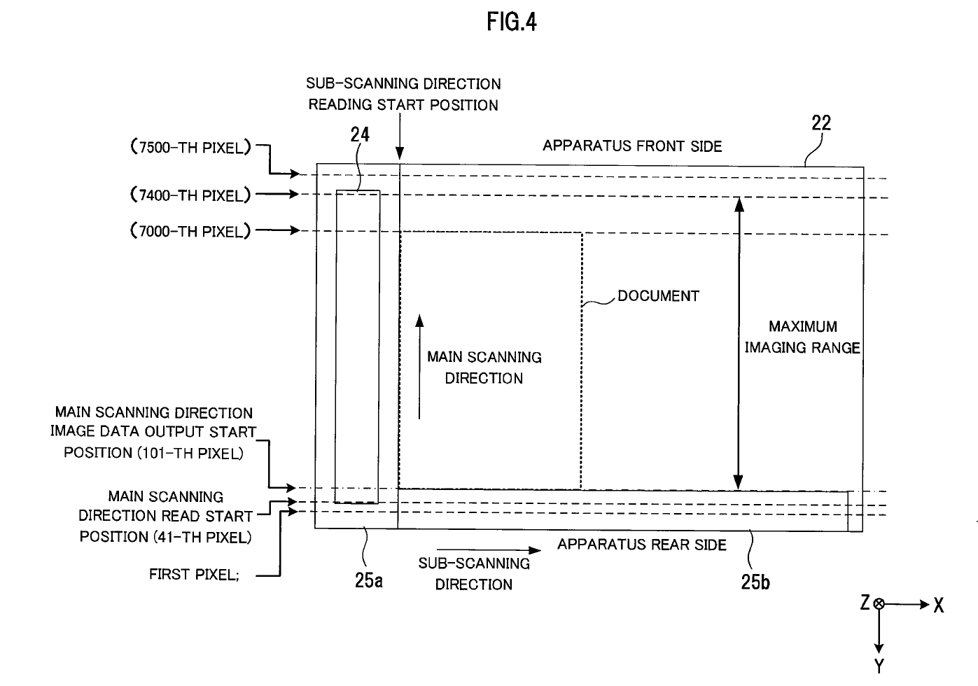

The process will be specifically described with reference to FIG. 4. FIG. 4 is a schematic view when the document glass 22 is seen from an arrow A direction in FIG. 2.

In the image forming apparatus 1 of the embodiment, in a state where the user stands in front of the image forming apparatus 1, the guide 25a is arranged at the left end of the document glass 22, and a guide 25b is arranged at the far side (rear side of the image forming apparatus 1). As indicated by a broken line in FIG. 4, a document is struck against the guide 25a and the guide 25b and is placed on the document glass 22.

In the state where the document is placed on the document glass 22 as stated above, the CCD sensor 42 can take an image in a range outside a range of the document glass 22 in the main scanning direction.

For example, when the number of pixels of the CCD sensor 42 is 7500, and when a sheet having a maximum width in the main scanning direction among sheets of reading objects in the image forming apparatus 1 is struck against the guide 25a and the guide 25b and is placed, a range (hereinafter referred to also as “maximum imaging range”) from one end position (guide position of the guide 25a) of the sheet to the other end position is assumed to correspond to a range from the 101-th pixel to the 7400-th pixel of the CCD sensor 42 (in FIG. 4, the illustrated pixel here is indicated in brackets. In the following explanation, a further exemplified pixel is also indicated in brackets.). In this case, 100 pixels which are not actually used for image data exist on each of both outsides of the maximum imaging range.

In the normal image reading process of the related art image forming apparatus, data corresponding to the respective pixels of the CCD sensor 42 are outputted from the AFE 100. When the read control part 102 acquires the data, only the data corresponding to the range from one end of the document in the main scanning direction to the other end of the document are adopted. For example, in the example of the foregoing number of pixels, when the range from the one end to the other end of the read document in the main scanning direction is, for example, from the 101-th pixel to the 7000-th pixel, data corresponding to the range from the first pixel to the 100-th pixel and from the 7001-th pixel to the 7400-th pixel are discarded, and the data corresponding to the range from the 101-th pixel to the 7000-th pixel are adopted.

On the other hand, as shown in FIG. 4, in the light-receiving elements of the CCD sensor 42 arranged in one line, the read control part 102 of the image forming apparatus 1 of the embodiment adopts image data starting from data of a pixel corresponding to a position outside a pixel corresponding to a position of one end of the document. Specifically, the read control part 102 adopts data starting from data corresponding to a position indicated as a main scanning direction read start position in FIG. 4.

When the document is read and copied in the image forming apparatus, or is stored as image data by the scanner function, a streak which appears to be caused by noises in various devices appears at a specified position on one end side of the image formed on the sheet by the copy process or the image data generated by the scan process. The various devices specifically include the ASIC in the read control part 102, a sensor to detect the size of the document, a board to control driving of the exposure lamp 28 and the like. In the data outputted from the read control part 102, among the data of each line read by the read control part 102, image data is changed by noises of these devices in the data of a pixel apart from the first pixel by a specified number of pixels, and as a result, a streak appears in the image. Although the pixel where the noise occurs varies according to the machine type of the image forming apparatus, for example, in the image forming apparatus 1 described in the embodiment, a streak can appear at a position corresponding to the 48-th pixel.

Then, the read control part 102 of the embodiment adopts data starting from data corresponding to a pixel at a position outside and apart from a position corresponding to one end of the document by a specified number of pixels, so that the noise is generated between the position where the adoption of the data starts and the position of the one end of the document. That is, the noise can be generated outside the range of the image of the document by this. Thus, in the after-mentioned image output control part 120, data in the range from the position of the end of the document necessary as the image to the main scanning direction read start position (that is, the data outside the document area and excessively read by the reading control part 102) is discarded, so that image data corresponding to the range of the image of the document where there is no noise can be generated. When a streak appears at the position corresponding to the 48-th pixel as in the illustrated example, the main scanning direction read start position is made a position outside and apart from the pixel corresponding to the position of the end of the document by about 60 pixels. Consequently, in the data of one line, the noise can be generated in the data in the range from the main scanning direction read start position to the position of the end of the document.

In the example of the number of pixels described above, among signals corresponding to the first pixel to the 7500-th pixel, the read control part 102 adopts the data in the range from the 41-th pixel at the position outside the position of the one end of the document to the 7000-th pixel corresponding to the position of the other end of the document. By this, the noise as the cause of the occurrence of the streak appears approximately at the 88-th pixel as the 48-th pixel from the 41-th pixel. Even if the influence of the noise appears in the signal of the 88-th pixel, since the finally adopted image data of the document is the data starting from the 101-th pixel, the streak can be prevented from appearing in the image formed on the sheet or the generated image data.

Next, the image output control part 120 adopts only the signals corresponding to the range from one end to the other end of the document among the signals read by the read control part 102, and outputs the signals to the image processing part 122. Specifically, as shown in FIG. 4, at the stage where signals are read by the read control part 102, the signals in the range from the main scanning direction read start position outside the one end of the document to the other end of the document are read. The image output control part 120 adopts the signals starting from a signal corresponding to a main scanning direction image data output start position corresponding to the position of the one end of the document among the signals including signals outside the range of the document. By this, the signals in the range from the main scanning direction read start position to the main scanning direction image data output start position, in which the streak appears by the noise, are discarded. Then, only the image data corresponding to the document except for the portion where the streak appears is outputted to the image processing part 122.

Incidentally, digital signals of respective pixels of each line are sequentially outputted from the read control part 102 to the image output control part 120 at timing of synchronization signals. Then, based on the timing signals outputted by the timing signal generation part 104, the image output control part 120 adopts only the signals in the foregoing range from the signals outputted from the read control part 102, and removes the signals in the range other than that.

Alternatively, for example, the image output control part 120 includes a counter circuit, and may perform such a process that when the leading signal of signals for one line is inputted, the signal count is started, and signals of a previously determined discarded number of pixels are discarded, and when the signals of the discarded number of pixels are counted, a signal input is received from the next signal.

In the example of the number of pixels described above, the reading control part 102 adopts the signals corresponding to the pixels from the 41-th pixel to the 7000-th pixel, and the range from the one end to the other end of the document in the main scanning direction corresponds to the pixels from the 101-th pixel to the 7000-th pixel . The range from the 41-th pixel to the 100-th pixel is unnecessary. Accordingly, the image output control part 120 discards the signals corresponding to the pixels from the 41-th pixel to the 100-th pixel among the signals corresponding to the pixels from the 41-th pixel to the 7000-th pixel inputted to the image output control part 120, and adopts the signals corresponding to the pixels from the 101-th pixel to the 7000-th pixel. The aforementioned noise generated by the operation of the ASIC and the like is included in the signals of the 41-th pixel to the 100-th pixel. Thus, the influence of the noise is not exerted on the adopted signals in the range from the 101-th to 7000-th pixel. When printing is performed based on the image data, an excellent image having no streak can be obtained unlike the related art.

The image processing part 122 performs various image processes on the image data outputted from the image output control part 120. The image processes include, for example, a color conversion process, a gamma correction process, an inking process, and a gradation change process. When copying is performed, the image data outputted to the image processing part 122 is temporarily stored in a page memory 128 of the system part 124.

The system part 124 controls the whole operation of the image forming apparatus 1. The system part 124 includes a page memory control part 126 and the page memory 128.

The page memory control part 126 controls a process of temporarily storing image data outputted from the image processing part 122 into the page memory 128. When printing in the copy process is started, the page memory control part 126 reads the image data stored in the page memory 128, and outputs the data to the writing control part 130 through the image processing part 122.

The writing control part 130 controls a process of forming an electrostatic latent image on the photoreceptor by a laser based on the image data of the image forming process object read from the page memory 128.

The above is the structure and the function of the image forming apparatus 1 of the embodiment.

According to the image forming apparatus 1 of the embodiment, when the document is read for the copy process or the scan process, the image data can be generated which is not influenced by the noise generated in the process of the pre-process, such as the shading correction, on the signal and has excellent picture quality.

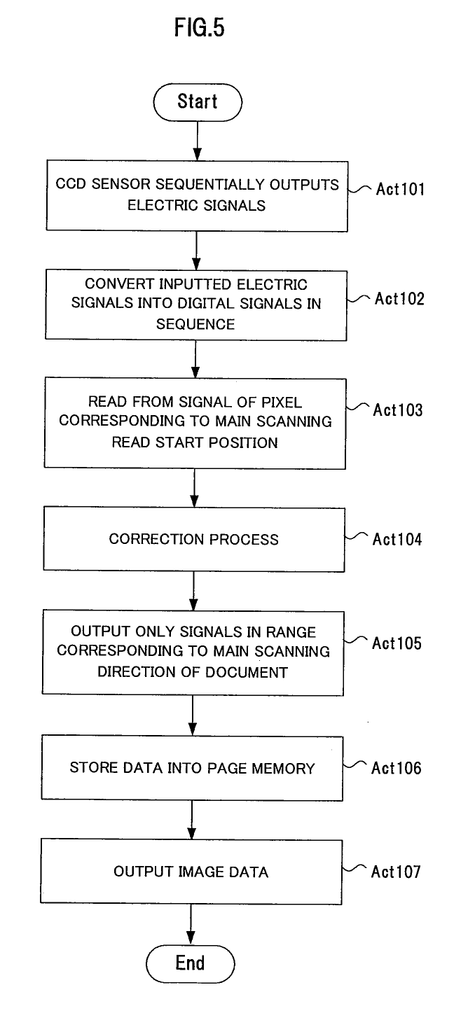

Next, a flow of a reading control method of image data in the image forming apparatus 1 of the embodiment will be described. FIG. 5 is a flowchart for explaining the flow of the reading control method.

First, the CCD sensor 42 reads the document, and the CCD sensor 42 sequentially outputs electric signals of respective pixels from the signal of the first pixel to the AFE 100 based on the control signal issued from the timing signal generation part 104 (Act 101).

Next, similarly the AFE 100 sequentially converts the inputted electric signals into digital signals based on the control signal from the timing signal generation part 104 and outputs the signals (Act 102).

Next, the read control part 102 discards the signals inputted at the timing earlier than the signal corresponding to the pixel corresponding to the main scanning direction read start position among the signals outputted from the AFE 100, and acquires the signals starting from the signal corresponding to the pixel corresponding to the main scanning direction read start position (Act 103). In the example of the number of pixels exemplified in FIG. 4, the read control part 102 discards the signals corresponding the pixels from the first pixel to the 40-th pixel, and adopts the signals starting from the signal corresponding to the 41-th pixel.

Next, the shading correction part 106 or the like performs a necessary correction process on the signals read by the read control part 102 (Act 104). The signals subjected to the correction process are sequentially outputted to the image output control part 120 from the read control part 102.

Next, the image output control part 120 performs a process of removing the signals corresponding to the range outside the position of the one end of the document and adopted in the read control part 102, and outputting only the signals corresponding to the range of the document in the main scanning direction as the image data (Act 105). In the example of the number of pixels exemplified in FIG. 4, the signals corresponding to the pixels from the 41-th pixel to the 100-th pixel are discarded, and the signals corresponding to the pixels from the 101-th pixel to the 7000-th pixel corresponding to the range of the document in the main scanning direction are adopted and are outputted.

Next, the page memory control part 126 sequentially stores the data outputted from the image output control part 120 into the page memory 128 until the data of one page are obtained (Act 106).

When the image data of the whole document are stored in the page memory 128, the image data are outputted to the image processing part 122 in order to perform a necessary image process (Act 107). Thereafter, when copying is performed, the image data is outputted to the writing control part 130, and the image forming process is performed. When the scan process is performed, a process is performed in which the image data stored in the page memory 128 is stored in a specified storage area.

The above is the flow of the image reading process by the image forming apparatus 1 of the embodiment.

As described above in detail, according to the embodiment, in the image data generated by the reading process, the image data of excellent picture quality can be generated and the image can be formed in which a streak is not generated at a specified position in the main scanning direction.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. A reading apparatus comprising:
an illuminator to irradiate an illumination light to a document of a reading object;
a CCD sensor that includes a plurality of light-receiving elements arranged in one line to receive the illumination light reflected by the document, and sequentially outputs electric signals stored in the light-receiving elements;
a read control part that acquires, with respect to the electric signals of each line generated by the CCD sensor, electric signals by reading the signals starting from an electric signal corresponding to a position outside one end, in a main scanning direction, which is one of both ends of the document of the reading target in the main scanning direction and is the end where an electric signal is outputted from the CCD sensor at an earlier timing;
a pre-processing part to perform a specified pre-process on the electric signals acquired by the read control part; and
an image output control part that removes, with respect to the electric signals of each line, electric signals corresponding to a range outside the one end from the electric signals processed by the pre-processing part, acquires electric signals starting from the electric signal corresponding to the one end, and outputs only the acquired electric signals to outside.

2. The apparatus of claim 1, wherein the outside position is the position corresponding to a pixel apart from the one end by more than pixels in a range from a pixel corresponding to a leading electric signal of the electric signals of each line inputted to the pre-processing part to a pixel corresponding to an electric signal influenced by a noise generated in the pre-processing part.

3. The apparatus of claim 1, wherein the image output control part counts the number of inputted electric signals by a counter, specifies the electric signal corresponding to the one end, and acquires the electric signals starting from the electric signal.

4. The apparatus of claim 3, further comprising a signal generation part to output synchronization signals to control timings when the electric signals are sequentially outputted from the CCD sensor.

5. The apparatus of claim 4, wherein the counter counts the number of electric signals based on the synchronization signals generated by the signal generation part.

6. The apparatus of claim 1, wherein the pre-processing part performs a shading correction which is a process to correct a variation in photoelectric conversion amounts of the plurality of light-receiving elements.

7. The apparatus of claim 1, wherein a position of the one end is a guide position of a guide member to guide a position of the document of the reading object.

8. An image forming apparatus comprising:
an illuminator to irradiate an illumination light to a document of a reading object;
a CCD sensor that includes a plurality of light-receiving elements arranged in one line to receive the illumination light reflected by the document, and sequentially outputs electric signals stored in the light-receiving elements;
a read control part that acquires, with respect to the electric signals of each line generated by the CCD sensor, electric signals by reading the electric signals starting from an electric signal corresponding to a position outside one end, in a main scanning direction, which is one of both ends of the document of the reading target in the main scanning direction and is the end where an electric signal is outputted from the CCD sensor at an earlier timing;
a pre-processing part to perform a specified pre-process on the electric signals acquired by the read control part;
an image output control part that removes, with respect to the electric signals of each line, electric signals corresponding to a range outside the one end from the electric signals processed by the pre-processing part, acquires electric signals starting from the electric signal corresponding to the one end, and outputs only the acquired electric signals to outside; and
an image forming process control part to perform an image forming process based on image data generated by the electric signals outputted from the image output control part.

9. The apparatus of claim 8, wherein the outside position is the position corresponding to a pixel apart from the one end by more than pixels in a range from a pixel corresponding to a leading electric signal of the electric signals of each line inputted to the pre-processing part to a pixel corresponding to an electric signal influenced by a noise generated in the pre-processing part.

10. The apparatus of claim 8, wherein the image output control part counts the number of inputted electric signals by a counter, specifies the electric signal corresponding to the one end, and acquires the electric signals starting from the electric signal.

11. The apparatus of claim 10, further comprising a signal generation part to output synchronization signals to control timings when the electric signals are sequentially outputted from the CCD sensor.

12. The apparatus of claim 11, wherein the counter counts the number of electric signals based on the synchronization signals generated by the signal generation part.

13. The apparatus of claim 8, wherein the pre-processing part performs a shading correction which is a process to correct a variation in photoelectric conversion amounts of the plurality of light-receiving elements.

14. An image reading control method, comprising:
irradiating an illumination light to a document of a reading object;
receiving the illumination light, which is reflected by the document, by a plurality of light-receiving elements arranged in one line, and sequentially outputting electric signals stored in the light-receiving elements by a CCD;
acquiring, with respect to the generated electric signals of each line, electric signals by reading the electric signals starting from an electric signal corresponding to a position outside one end, in a main scanning direction, which is one of both ends of the document of the reading target in the main scanning direction and is the end where an electric signal is outputted at an earlier timing;
performing a specified pre-process on the acquired electric signals; and
removing, with respect to the electric signals of each line, electric signals corresponding to a range outside the one end from the pre-processed electric signals, starting to acquire electric signals starting from the electric signal corresponding to the one end, and outputting only the acquired electric signals to outside.

15. The method of claim 14, wherein the outside position is the position corresponding to a pixel apart from the one end by more than pixels in a range from a pixel corresponding to a leading electric signal of the electric signals of each line inputted for the pre-process to a pixel corresponding to an electric signal influenced by a noise generated in the pre-process.

16. The method of claim 14, wherein with respect to the electric signals of each line, when the electric signals corresponding to the range outside the one end are removed from the pre-processed electric signals, and the electric signals starting from the electric signal corresponding to the one end are acquired, the number of inputted electric signals is counted by a counter to specify the electric signal corresponding to the one end, and the electric signals starting from the electric signal are acquired.

17. The method of claim 16, further comprising:
outputting synchronization signals to control timings when the electric signals are sequentially outputted from the CCD.

18. The method of claim 17, wherein the counter counts the number of electric signals based on the outputted synchronization signals.

19. The method of claim 14, wherein the pre-process is a shading correction which is a process to correct a variation in photoelectric conversion amounts of the plurality of light-receiving elements.

20. The method of claim 14, wherein a position of the one end is a guide position of a guide member to guide a position of the document of the reading object.
